(19) United States
(12) Patent Application Publication
(10) Pub. No.: US 2013/0244206 A1
(43) Pub. Date: Sep. 19, 2013

(54) PATIENT-SPECIFIC SYSTEM FOR RESTORING MISSING DENTITION

(71) Applicant: JAMES R. GLIDEWELL DENTAL CERAMICS, INC., Newport Beach, CA (US)

(72) Inventors: Grant Bullis, Newport Beach, CA (US); Greg Minzenmayer, Foothill Ranch, CA (US)

(73) Assignee: James R. Glidewell Dental Ceramics, Inc., Newport Beach, CA (US)

(21) Appl. No.: 13/804,174

(22) Filed: Mar. 14, 2013

Related U.S. Application Data
(60) Provisional application No. 61/612,194, filed on Mar. 16, 2012.

(51) Int. Cl. A61C 8/00; A61C 13/00

(52) U.S. Cl. CPC A61C 8/009; A61C 8/008; A61C 8/0001; A61C 8/0068; A61C 13/0004
USPC 433/173

(57) ABSTRACT

A patient-specific system for restoring missing dentition may include surgical components including a dental implant drilling guide adapted to the patient's dental anatomy, dental implant, drills required to place said implant, and drilling depth and sequence instructions specific to the patient. Further, the system includes a patient-specific healing abutment to form a customized emergence profile, an impression coping with the same emergence profile, a provisional abutment with the same emergence profile, a final abutment with the same emergence profile, a provisional crown or bridge, and a final crown or bridge. The crown or bridge may be screw or cement retained.

### RELATED APPLICATION

This application claims the benefit of and priority to U.S. Provisional Patent Application No. 61/612,194, filed on Mar. 16, 2012, the entirety of which application is incorporated herein by reference.

### FIELD

The present disclosure generally relates to a system to restore dentition utilizing dental implants and patient-specific surgical and restorative components. Specifically, drilling instructions and a guide for implant placement are created with the optimal prosthetic outcome, and the healing abutment, temporary abutment, impression coping and final abutment have the same, custom emergence profile, which forms the gingival tissue surrounding the implant, and which is unique to each patient.

### BACKGROUND

Pre-manufactured dental implant surgical and prosthetic components to shape the patient's gingival tissue to achieve a more anatomically correct emergence profile are known. According to one prior art technique, a healing cap for providing a predetermined oval contour to the gingival tissue is described. A number of problems and restrictions are presented, however, with the use of pre-manufactured surgical and prosthetic components. Specifically, the anatomically correct emergence profile of a patient is unique to that patient. Pre-manufactured surgical and prosthetic components for dental implant restoration can only approximate general emergence profiles intended to fit reasonably well with the anatomical assumptions made during the design of those pre-manufactured components.

### SUMMARY

The patient-specific surgical and prosthetic components of the present invention and the method for their use provide a means for achieving a more predictable restorative outcome because the implant placement and emergence profile are designed and manufactured specifically for each patient's unique anatomy to achieve an optimal prosthetic outcome.

A patient-specific system for restoring missing dentition is provided herein. In one embodiment, the system includes surgical components including a dental implant drilling guide adapted to the patient's dental anatomy, dental implant, drills required to place said implant, and drilling depth and sequence instructions specific to the patient. Further, the system includes a patient-specific healing abutment to form a customized emergence profile, an impression coping with the same emergence profile, a provisional abutment with the same emergence profile, a final abutment, a provisional crown or bridge, and a final crown or bridge. The crown or bridge may be screw or cement retained.

In an embodiment, a patient-specific system for restoring missing dentition is provided. The system includes a dental implant drilling guide adapted to the dental anatomy of a patient, a dental implant, one or more drills required to place the implant, drilling depth and sequence instructions specific to the patient, and patient-specific components having a customized emergence profile including: a healing abutment, an impression coping, a provisional abutment, and a final abutment. The patient-specific components have the same customized emergence profile geometry.

The system may further include a provisional crown or bridge, and a final crown or bridge. The final crown or bridge may be retained using a screw or cement.

The patient specific components may include an implant contact region configured to connect the bottom of the patient-specific components to the dental implant. The patient-specific emergence profile geometry of the patient-specific components may be designed by computer-aided design (CAD). The designed geometry may be produced by computer-aided machining (CAM). The patient-specific components may have the same or substantially the same emergence profile geometry intended to form the gingival tissue.

Each patient-specific component may have an opening that extends through at least a portion thereof. The opening may provide access for a screw. The screw may secure the patient-specific components to the dental implant.

In an embodiment, a patient-specific system for restoring missing dentition is provided. The system includes a dental implant drilling guide adapted to the dental anatomy of a patient, a dental implant, one or more drills required to place the dental implant in the patient, drilling depth and sequence instructions specific to the patient, a healing abutment, an impression coping, a provisional abutment, a final abutment, a provisional prosthetic, and a final prosthetic, wherein the healing abutment, the impression coping, the provisional abutment, and the final abutment are patient-specific components having the same customized emergence profile geometry. The patient-specific components may include an implant contact region configured to connect to the dental implant. The customized emergence profile geometry of the patient-specific components may be designed by means of computer-aided design (CAD), and the designed geometry may be produced by computer-aided machining (CAM).

In an embodiment, a patient-specific system for restoring missing dentition includes: one or more dental implant surgical components, a healing abutment, an impression coping, a provisional abutment, a final abutment, a provisional crown or bridge, and a final crown or bridge. The healing abutment, the impression coping, the provisional abutment, and the final abutment are patient-specific components having the same customized emergence profile geometry. Also, the emergence profile geometry of the patient-specific components includes an implant contact region configured to connect to the dental implant.

The one or more dental implant surgical components may include one or more patient-specific surgical components such as a dental implant drilling guide adapted to the dental anatomy of a patient, drilling depth and sequence instructions specific to the patient, a dental implant, one or more drills required to place the dental implant in the patient, or a combination thereof. The one or more dental implant surgical components may include: a dental implant drilling guide adapted to the dental anatomy of a patient, a dental implant, one or more drills required to place the implant, and drilling depth and sequence instructions specific to the patient.

The customized emergence profile geometry of the patient-specific components may be designed by means of computer-aided design (CAD) and the designed geometry may be produced by computer-aided machining (CAM).

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a side view of a healing abutment, impression coping, and temporary abutment with matching, patient-specific emergence profile geometry having, at the bottom, an implant contact region with geometry to connect to the implant;

FIG. 2 is an embodiment of tooth replacement system components including a dental implant drilling guide adapted to the patient's dental anatomy, dental implant, drills required to place said implant, drilling depth and sequence instructions specific to the patient, patient-specific healing abutment to form a customized emergence profile, an impression coping with the same emergence profile, a provisional abutment with the same emergence profile, a final abutment with the same emergence profile, a provisional crown, and a final crown; and

FIG. 3 is an example of patient-specific drilling depth and sequence instructions.

### DETAILED DESCRIPTION

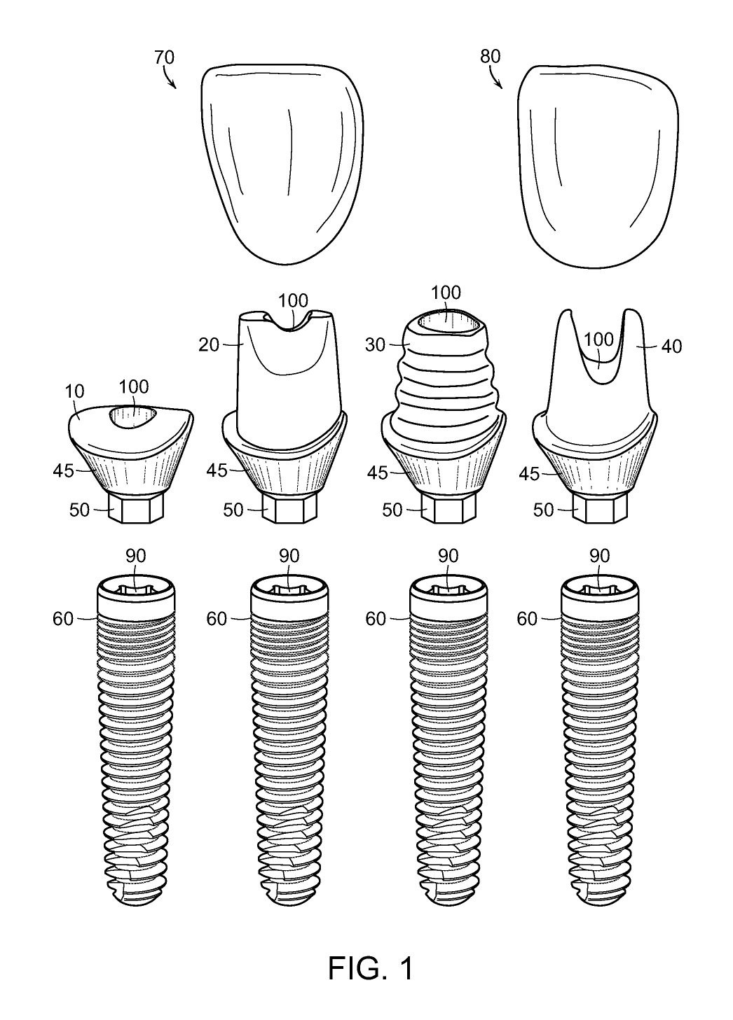

Referring now to the drawings in detail, FIG. 1 is a side view of an embodiment of patient-specific components including a healing abutment 10, temporary abutment 20, impression coping 30, and final abutment 40 with matching patient-specific emergence profiles 45 and patient-specific emergence profile geometry. At the bottom of each component 10, 20, 30, 40 is an implant contact region 50 with geometry to connect to the dental implant 60. Also shown in FIG. 1 is a provisional crown 70 for placement on the temporary abutment 20, and a final crown 80 for placement on the final abutment 40.

In one embodiment, the patient-specific emergence profile geometry of these components is designed by means of computer-aided design (CAD) and the designed geometry is produced by computer-aided machining (CAM).

Regardless of the method of design or manufacture, the patient-specific components 10, 20, 30, 40 share the same, or substantially similar emergence profile geometry intended to form the gingival tissue.

To provide access for a screw that engages threads of an internal bore 90 in the dental implant 60, the patient-specific components 10, 20, 30, 40 may have a central opening 100. The opening 100 may have a bore that extends through the entire axis of the component. The bore has a seating area for the head of a screw. The screw includes a head and a lower section having external threads thereon. The screw is threaded into an internally threaded bore of the dental implant. The screw secures the patient-specific components 10, 20, 30, 40 to the dental implant 60. These components 10, 20, 30, 40 have a prosthetic connection to interface with the dental implant 60. The dental implant 60 also has threads for engaging the bone of the dental arches (including the maxillary and mandible). The dental implant 60 is located below a gingival surface and contacts a dental arch (not shown).

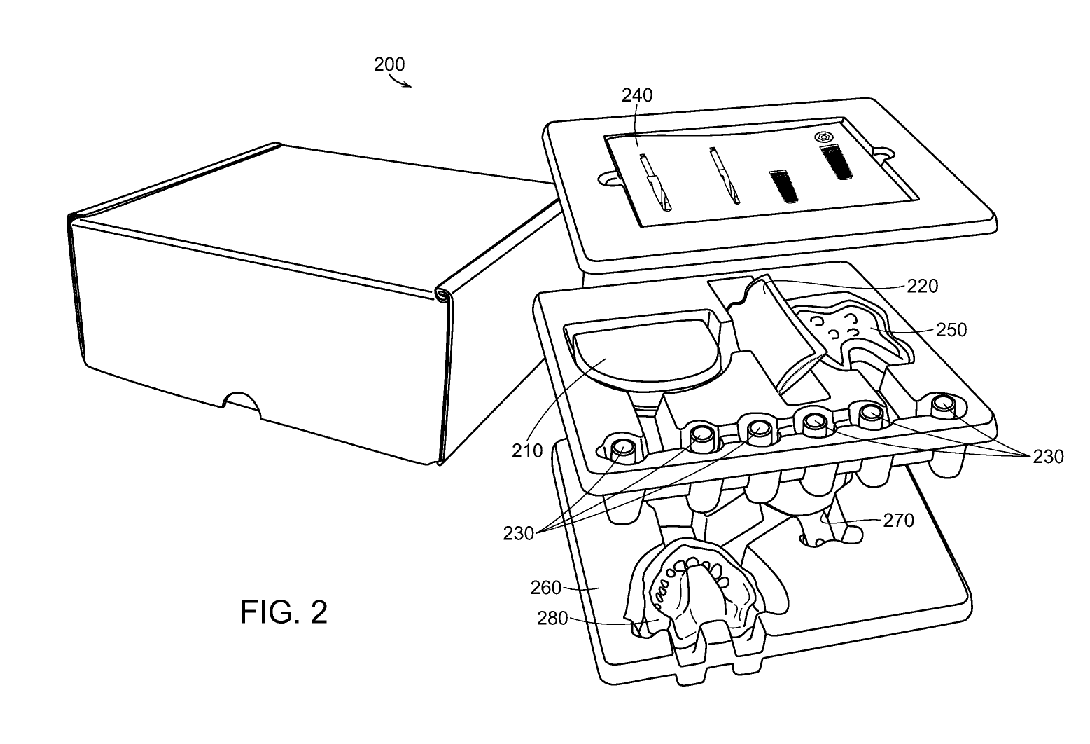

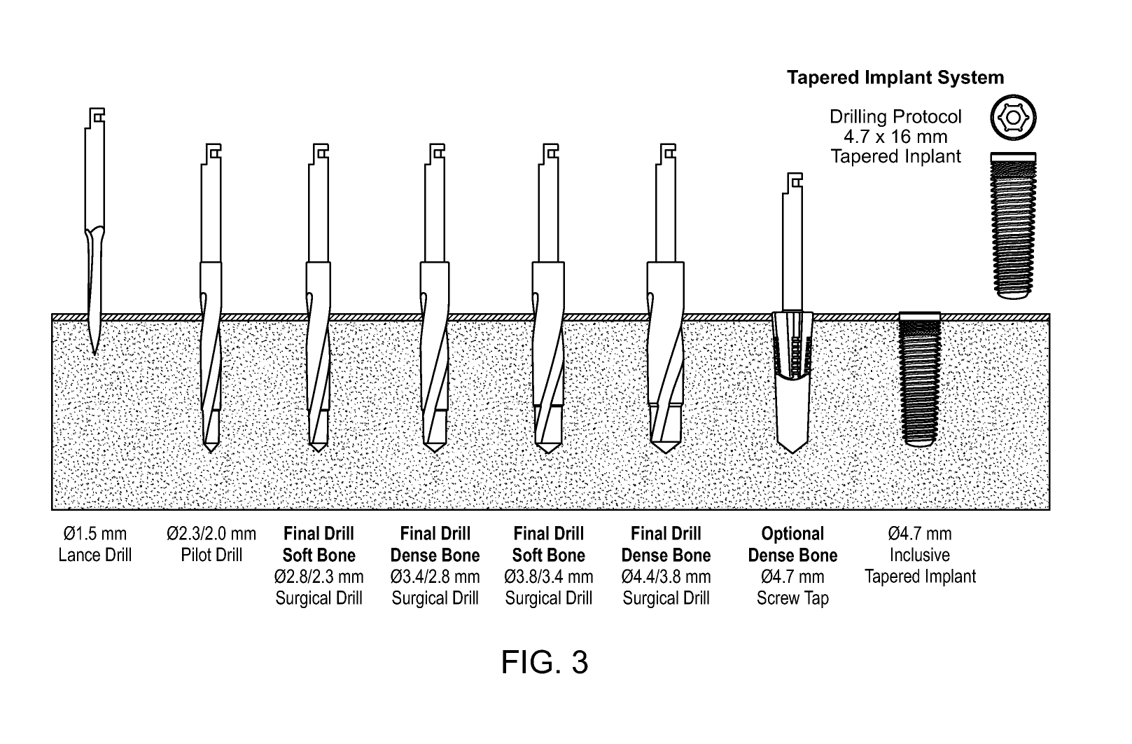

FIG. 2 shows an embodiment of a tooth replacement system 200 including various components that may be in the system 200. Shown therein are a dental implant drilling guide adapted to the patient's dental anatomy (contained in box 210), a dental implant 60 (in package 220), drills 230 required to place said implant, drilling depth and sequence instructions 240 specific to the patient (see also FIG. 3), and the following items contained in box 250 (see also FIG. 1): a patient-specific healing abutment 10 to form a customized emergence profile 45, an impression coping 20 with the same emergence profile 45, a provisional abutment 30 with the same emergence profile 45, a final abutment 40 with the same emergence profile 45, a provisional crown 70, and a final crown 80. The system 200 may also include a tray 260 having recesses for holding impressions 270, 280.

FIG. 3 is an example of patient-specific drilling depth and sequence instructions.

While the invention is susceptible to various modifications and alternative forms, a specific embodiment thereof has been shown by way of example in the drawings. It should be understood, however, that it is not intended to limit the invention to the particular forms disclosed but, on the contrary, the intention is to cover all modifications, equivalents, and alternatives falling within the spirit and scope of the invention.

While the present invention has been described with reference to one or more particular embodiments, those skilled in the art will recognize that many changes may be made thereto without departing from the spirit and scope of the present invention. Each of these embodiments and variations thereof is contemplated as falling within the spirit and scope of the disclosed invention.

We claim:

1. A patient-specific system for restoring missing dentition comprising:
a dental implant drilling guide adapted to the dental anatomy of a patient, a dental implant,
one or more drills required to place the implant,
drilling depth and sequence instructions specific to the patient,
patient-specific components having a customized emergence profile including: a healing abutment, an impression coping, a provisional abutment, and a final abutment;
wherein the patient-specific components have the same customized emergence profile geometry.

2. The system of claim 1, further comprising: a provisional crown or bridge; and a final crown or bridge.

3. The system of claim 2, wherein the final crown or bridge is retained using a screw or cement.

4. The system of claim 1, wherein the patient specific components include an implant contact region configured to connect the bottom of the patient-specific components to the dental implant.

5. The system of claim 1, wherein the customized emergence profile geometry of the patient-specific components is designed by computer-aided design (CAD).

6. The system of claim 1, wherein the customized emergence profile geometry of the patient-specific components is designed by computer-aided design (CAD) and the designed geometry is produced by computer-aided machining (CAM).

7. The system of claim 1, wherein the patient-specific components have the same or substantially the same emergence profile geometry intended to form the gingival tissue.

8. The system of claim 1, wherein each patient-specific component has an opening that extends through at least a portion of the component.

9. The system of claim 8, wherein the opening provides access for a screw.

10. The system of claim 9, wherein the screw secures the patient-specific components to the dental implant.

11. A patient-specific system for restoring missing dentition comprising:
a dental implant drilling guide adapted to the dental anatomy of a patient,
a dental implant,
one or more drills required to place the dental implant in the patient,
drilling depth and sequence instructions specific to the patient,
a healing abutment,
an impression coping,
a provisional abutment,
a final abutment,
a provisional prosthetic, and
a final prosthetic,
wherein the healing abutment, the impression coping, the provisional abutment, and the final abutment are patient-specific components having the same customized emergence profile geometry.

12. The system of claim 11, wherein each patient-specific component includes an implant contact region configured to connect the bottom of the patient-specific component to the dental implant.

13. The system of claim 11, wherein the customized emergence profile geometry of the patient-specific components is designed by means of computer-aided design (CAD) and the designed geometry is produced by computer-aided machining (CAM).

14. A patient-specific system for restoring missing dentition comprising:
one or more dental implant surgical components,
a healing abutment,
an impression coping,
a provisional abutment,
a final abutment,
a provisional crown or bridge, and
a final crown or bridge,
wherein the healing abutment, the impression coping, the provisional abutment, and the final abutment are patient-specific components having the same customized emergence profile geometry, and
wherein the patient-specific components include an implant contact region configured to connect to the dental implant.

15. The system of claim 14, wherein the one or more dental implant surgical components comprise one or more patient-specific surgical components.

16. The system of claim 15, wherein the patient-specific surgical components include:
a dental implant drilling guide adapted to the dental anatomy of a patient, and drilling depth and sequence instructions specific to the patient.

17. The system of claim 14, wherein the one or more dental implant surgical components comprise a dental implant.

18. The system of claim 14, wherein the one or more dental implant surgical components comprise one or more drills required to place the dental implant in the patient.

19. The system of claim 14, wherein the one or more dental implant surgical components include:
a dental implant drilling guide adapted to the dental anatomy of a patient,
a dental implant,
one or more drills required to place the implant, and
drilling depth and sequence instructions specific to the patient.

20. The system of claim 14, wherein the customized emergence profile geometry of the patient-specific components is designed by means of computer-aided design (CAD) and the designed geometry is produced by computer-aided machining (CAM).
